(19) United States
(12) Patent Application Publication
(10) Pub. No.: US 2011/0103269 A1
(43) Pub. Date: May 5, 2011

(54) WIRELESS COMMUNICATION SYSTEM AND RELAY STATION AND WIRELESS COMMUNICATION DEVICE THEREOF

(75) Inventor: Yan-Xiu Zheng, Taipei County (TW)

(73) Assignee: INDUSTRIAL TECHNOLOGY RESEARCH INSTITUTE, Hsinchu (TW)

(21) Appl. No.: 12/907,040

(22) Filed: Oct. 19, 2010

Related U.S. Application Data
(60) Provisional application No. 61/256,033, filed on Oct. 29, 2009.

(30) Foreign Application Priority Data
Sep. 24, 2010 (TW) 99132434

(51) Int. Cl. H04J 4/00; H04W 4/00; H04J 1/00; H04J 3/00

(52) U.S. Cl. 370/279; 370/315

(57) ABSTRACT

A wireless communication system and a relay station and a wireless communication device thereof are provided. The wireless communication system includes at least a base station, at least a relay station, and at least a wireless communication device. The relay station is wirelessly connected to the base station. The wireless communication device is wirelessly connected to the relay station. At least two uplinks of the wireless communication system are inband or on the same carrier, and at least two downlinks of the wireless communication system are outband or on different carriers.

### CROSS-REFERENCE TO RELATED APPLICATION

This application claims the priority benefit of U.S.A. provisional application Ser. No. 61/256,033, filed on Oct. 29, 2009, all disclosures are incorporated therewith. This application also claims the priority of Taiwan application serial no. 99132434, filed Sep. 24, 2010. All disclosure of the Taiwan application is incorporated herein by reference.

### TECHNICAL FIELD

The disclosure relates to a wireless communication system and a relay station and a wireless communication device thereof.

### BACKGROUND

Relay techniques are adopted in the wireless communication technology to improve wireless communication coverage with high transmission rate, group mobility, and cell-edge throughputs of base stations and to provide temporary network deployments. A relay station is usually connected to a base station and further connected to a radio access network in a wireless transmission approach. A relay station may adopt an inband connection or an outband connection. The inband connection refers to the situation where the link from a radio access network to a relay station and the link from the radio access network to a wireless communication device (or a wireless terminal communication device) both share the same band or the same carrier. On the contrary, the outband connection refers to the situation where the link from the radio access network to the relay station and the link from the radio access network to the wireless communication device (or the wireless terminal communication device) use different bands or different carrier.

Moreover, the link of a relay station may be transparent or non-transparent.

If a relay station is transparent, a wireless communication device (or also called UE) does not know whether it communicates with a radio access network through any relay station. On the contrary, if a relay station is non-transparent, the wireless communication device (or an UE) knows whether it communicates with the radio access network through any relay station. Currently, the IEEE 802.16j standard is a wireless communication system standard that adopts relay techniques. However, there are other communication system standards that use relay stations, such as the IEEE 802.16m standard, and the Third Generation Partnership Project Long Term Evolution Advanced (3GPP LTE-Advanced) standard.

FIG. 1A is a schematic diagram illustrating a conventional wireless communication system 10 with a type 1 relay station. The wireless communication system 10 includes a base station 101, a type 1 relay station 102, and a wireless communication device 103. The type 1 relay station 102 adopts a non-transparent relay technique. The type 1 relay station 102 controls its own cell coverage area and may control one or more cells. The type 1 relay station 102 has a unique physical layer cell identity. From the perspective of the wireless communication device 103, the type 1 relay station 102 and the base station 101 have the same radio resource management (RRM). The type 1 relay station 102 is similar to a layer 3 relay communication device, such as a type 1 relay node with a self-backhauling function.

The 3GPP LTE-Advanced standard supports type 1 relay stations. For example, it is defined in the 3GPP Release 8 standard that a type 1 relay station can transmit its own one or more synchronization channels and one or more reference symbols. In a context of single-cell operation, the wireless communication device 103 receives schedule information and a hybrid-automatic repeat request (HARQ) feedback signal transmitted from the type 1 relay station 102 and sends its own control signalling data or control channel (for example, SR/CQI/ACK) back to the type 1 relay station 102. In terms of operation, if the wireless communication device 103 is a UE conforming to 3GPP Release 8 standard, the type 1 relay station 102 is then an advanced base station (or also called an eNodeB) conforming to 3GPP Release 8 standard.

FIG. 1B is a schematic diagram illustrating the transmitting/receiving mechanism of downlinks from the base station 101 to the wireless communication device 103 via the relay station 102 in the wireless communication system illustrated in FIG. 1A. Referring to both FIG. 1A and FIG. 1B, both the downlinks (including the downlink from the type 1 relay station 102 to the wireless communication device 103 and the downlink from the base station 101 to the type 1 relay station 102) in the wireless communication system 10 adopt a time division multiplexing (TDM) mode. In FIG. 1B, time is divided into a time slot 1 and a time slot 2, where the time slot 1 is the downlink of the type 1 relay station 102, and the time slot 2 is the downlink of the wireless communication device 103. Since the two links are combined on the same carrier by adopting the TDM mode or the type 1 relay station 102 is an inband relay station, the highest transmission rate is reduced due to the TDM.

The uplink from the type 1 relay station 102 to the base station 101 and the uplink from the wireless communication device 103 to the type 1 relay station 102 may also share the same carrier. If a frequency division duplex (FDD) mode is adopted, the uplinks also share the carrier through a TDM mode, as similar to the downlinks. If a time division duplex (TDD) mode is adopted, another two time slots are further divided from the carrier respectively for the two uplinks.

FIG. 2A is a schematic diagram illustrating a conventional wireless communication system 20 with a type 2 relay station. The wireless communication system 20 includes a base station 201, a type 2 relay station 202, and a wireless communication device (or a wireless terminal communication device) 203. The type 2 relay station 202 adopts a transparent and inband relay technique and has no physical layer cell identity (but may still have a relay identity). From the perspective of the wireless communication device 203, the base station 201 is a donor cell of the wireless communication system 20 and has the primary control, and the base station 201 has at least parts of the RRM and directly controls the wireless communication device 203. However, other parts of the RRM is carried out by the type 2 relay station 202. The type 2 relay station 202 is similar to a smart repeater communication device, a decode-and-forward communication device, or a layer 2 relay communication device.

FIG. 2B is a schematic diagram illustrating the transmitting/receiving mechanism of the wireless communication system in FIG. 2A. Referring to both FIG. 2A and FIG. 2B, all the downlinks (including the downlink from the type 2 relay station 202 to the wireless communication device 203, the downlink from the base station 201 to the type 2 relay station 202, and the downlink from the base station 201 to the wireless communication device 203) in the wireless communication system 20 adopt the TDM mode. Since the downlink of the wireless communication device 203 and the downlink of the type 2 relay station 202 share the same carrier, the wireless communication device 203 can just receive data by using the time slot 2, so that the wireless communication device 203 cannot achieve its better transmission rate.

The uplink from the type 2 relay station 202 to the base station 201 and the uplink from the wireless communication device 203 to the type 2 relay station 202 may also share the same carrier. If the FDD mode is adopted, the uplinks also share the carrier through a TDM mode, as similar to the downlinks. If the TDD mode is adopted, two time slots are further divided from the carrier for the uplinks.

The 3GPP LTE-Advanced standard supports type 2 relay stations. For example, according to the 3GPP Release 8 standard, the interface between the base station 201 and the type 2 relay station 202 in a cell is a Un interface, and the interface between the type 2 relay station 202 and the wireless communication device 203 is a Uu interface, where the Un interface and the Uu interface are inband connection. In the context of single-cell operation, since the type 2 relay station 202 has no physical layer cell identity, no new cell is created. The wireless communication device 203 is not aware of the type 2 relay station 202 working in the cell. However, according to the 3GPP Release 8 standard, the type 2 relay station 202 can transmit a physical downlink shared channel (PDSCH) but does not transmit at least a common reference signal (CRS) and a physical downlink control channel (PDCCH).

FIG. 3 is a diagram illustrating a transition gap caused by a relay station. The transition gap may be a transmit transition gap (TTG) or a receive transition gap (RTG). As shown in FIG. 3, after the relay station receives data or a control signal in the time slot 1, it cannot directly relay the data or control signal to the wireless communication device. There is required a gap for transiting from receiving state to transmitting state between the time slot 1 and the time slot 2 such that the wireless communication device can receive the data or control signal from the relay station in the time slot 2. Similarly, there is also a gap for transiting from transmitting state to receiving state in an uplink. These transition gaps cause waste of radio resources.

Additionally, since a relay station always uses the same band during a transmitting process and a receiving process, the wireless communication device cannot utilize entire time during the transmitting process and the receiving process. As can be understood from foregoing descriptions related to FIG. 1B and FIG. 2B, the wireless communication device does not receive any data or control signal in the time slot 1. Thus, a user may experience slow down of the transmission rate. Even if the wireless communication device can process a large bandwidth (for example, 20 MHz), the wireless communication device cannot achieve its highest transmission rate since it cannot receive data during some period of time. To be more specific, as can be understood from foregoing descriptions related to FIG. 1A-FIG. 2B, the reception throughput of a wireless communication device is limited by the number of carriers used by the downlinks and the operation time of each of the downlinks. Therefore, how to reduce the transition gaps and radio resource waste of a wireless communication system with relay stations and improve the data transmission efficiency thereof has become a major concern in the industry.

### SUMMARY

A wireless communication system and a relay station and a wireless communication device thereof are introduced herein.

According to an exemplary embodiment of the disclosure, a wireless communication system is introduced. The wireless communication system includes at least a base station, at least a relay station, and at least a wireless communication device. The relay station is wirelessly connected to the base station. The wireless communication device is wirelessly connected to the relay station. At least two uplinks of the wireless communication system are inband, and at least two downlinks of the wireless communication system are outband.

According to an exemplary embodiment of the disclosure, a wireless communication system is introduced. The wireless communication system includes at least a base station, at least a relay station, and at least a wireless communication device. The relay station is wirelessly connected to the base station, where a frequency division duplex (FDD) mode is adopted as a first transmission mode between the base station and the relay station. The wireless communication device is wirelessly connected to the relay station, where a time division duplex (TDD) mode is adopted as a second transmission mode between the relay station and the wireless communication device.

According to an exemplary embodiment of the disclosure, a relay station is introduced. The relay station is adapted for relaying data or control signalling data between at least a base station and at least a wireless communication device. A first uplink of the relay station and a second uplink of the wireless communication device are inband, and a first downlink of the relay station and a second downlink of the wireless communication device are outband.

According to an exemplary embodiment of the disclosure, a relay station is introduced. The relay station is adapted for relaying data or control signalling data between at least a base station and at least a wireless communication device. An FDD mode is adopted as a first transmission mode between the relay station and the base station, and a TDD mode is adopted as a second transmission mode between the relay station and the wireless communication device.

According to an exemplary embodiment of the disclosure, a wireless communication device is introduced. The wireless communication device is adapted for communicating with at least one base station through at least one relay station. An FDD mode is adopted as a transmission mode between the wireless communication device and the relay station. A frequency division multiplexing (FDM) mode is adopted by a first downlink of the wireless communication device and a second downlink of the relay station. A first uplink of the wireless communication device and a second uplink of the relay station share a same carrier.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1A is a schematic diagram illustrating a conventional wireless communication system with a type 1 relay station.

FIG. 1B is a schematic diagram illustrating the transmitting/receiving mechanism of the wireless communication system in FIG. 1A.

FIG. 2A is a schematic diagram illustrating a conventional wireless communication system with a type 2 relay station.

FIG. 2B is a schematic diagram illustrating the transmitting/receiving mechanism of the wireless communication system in FIG. 2A.

FIG. 3 is a schematic diagram illustrating a transition gap caused by a relay station.

FIG. 4A is a schematic diagram illustrating a wireless communication system with a type 2 relay station according to a first exemplary embodiment.

FIG. 4B is a schematic diagram illustrating the transmitting/receiving mechanism of the wireless communication system in FIG. 4A.

FIG. 5A is a schematic diagram illustrating a wireless communication system with a type 1 relay station according to a second exemplary embodiment.

FIG. 5B is a schematic diagram illustrating the transmitting/receiving mechanism of the wireless communication system in FIG. 5A.

FIG. 6A is a schematic diagram illustrating a wireless communication system with a type 2 relay station according to a third exemplary embodiment.

FIG. 6B is a schematic diagram illustrating the transmitting/receiving mechanism of the wireless communication system in FIG. 6A.

FIG. 7A is a schematic diagram illustrating a wireless communication system with a type 1 relay station according to a fourth exemplary embodiment.

FIG. 7B is a schematic diagram illustrating the transmitting/receiving mechanism of the wireless communication system in FIG. 7A.

FIG. 8A is a schematic diagram illustrating a wireless communication system with a type 2 relay station according to a fifth exemplary embodiment.

FIG. 8B is a schematic diagram illustrating the transmitting/receiving mechanism of the wireless communication system in FIG. 8A.

### DETAILED DESCRIPTION OF DISCLOSED EMBODIMENTS

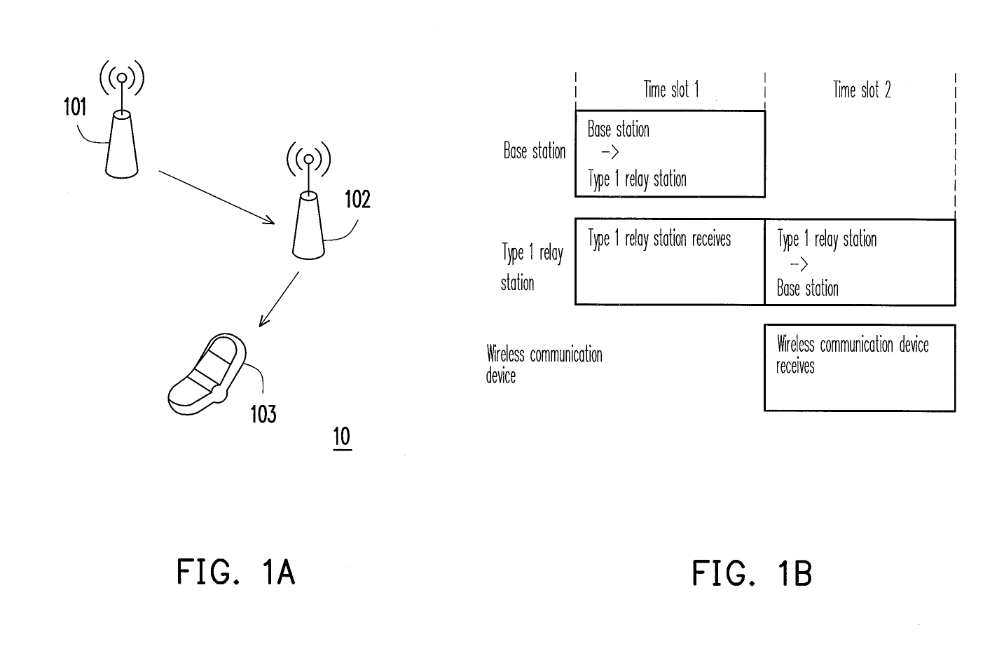

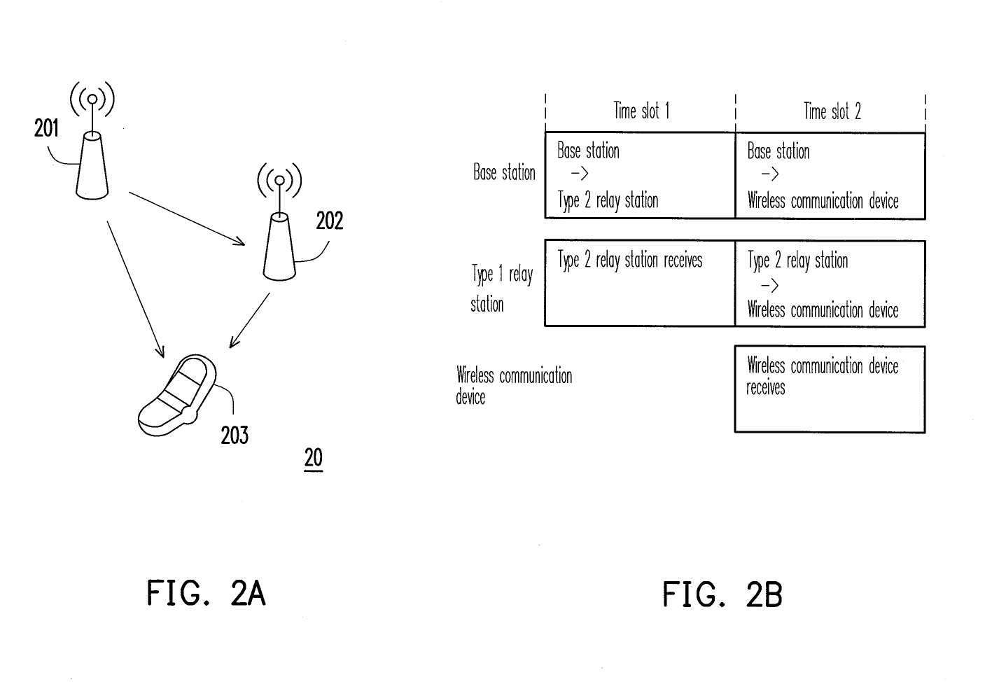

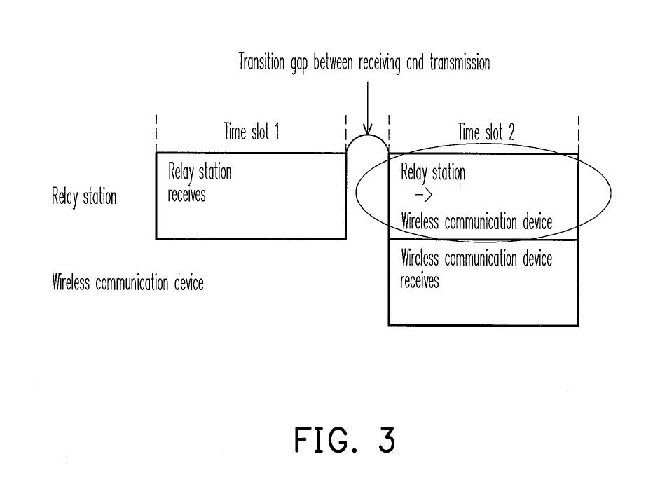

According to exemplary embodiments of the present disclosure, a downlink from a base station to a relay station and another downlink from the relay station to a wireless communication device (user equipment, also called UE) are separated into different carriers, so that the interface between the relay station and the wireless communication device and the interface between the base station and the relay station do not share a same carrier. Accordingly, the wireless communication device can entirely use the carrier of the interface between the relay station and the wireless communication device in some cases, and, meanwhile, the transition gaps between transmitting and receiving procedures is not required. Moreover, an uplink from the relay station to the base station and an uplink from the wireless communication device to the relay station share the same carrier or radio resource. Based on foregoing different carrier configurations and operations regarding uplinks and downlinks, if it is required to avoid reduction on downlink highest transmission rate and lowering of the user experience of the wireless communication device, just 3 carriers are required in exemplary embodiments of the disclosure to effectively maintain the highest transmission rate between the relay station and the wireless communication device, as compared to the conventional techniques illustrated in FIG. 1A and FIG. 2A, where at least four carriers are required to retain the highest downlink transmission rate. The wireless communication devices in exemplary embodiments of the disclosure can be, for example, digital TVs, digital set-top boxes, notebook computers, tablet PCs, mobile phones, or smart phones.

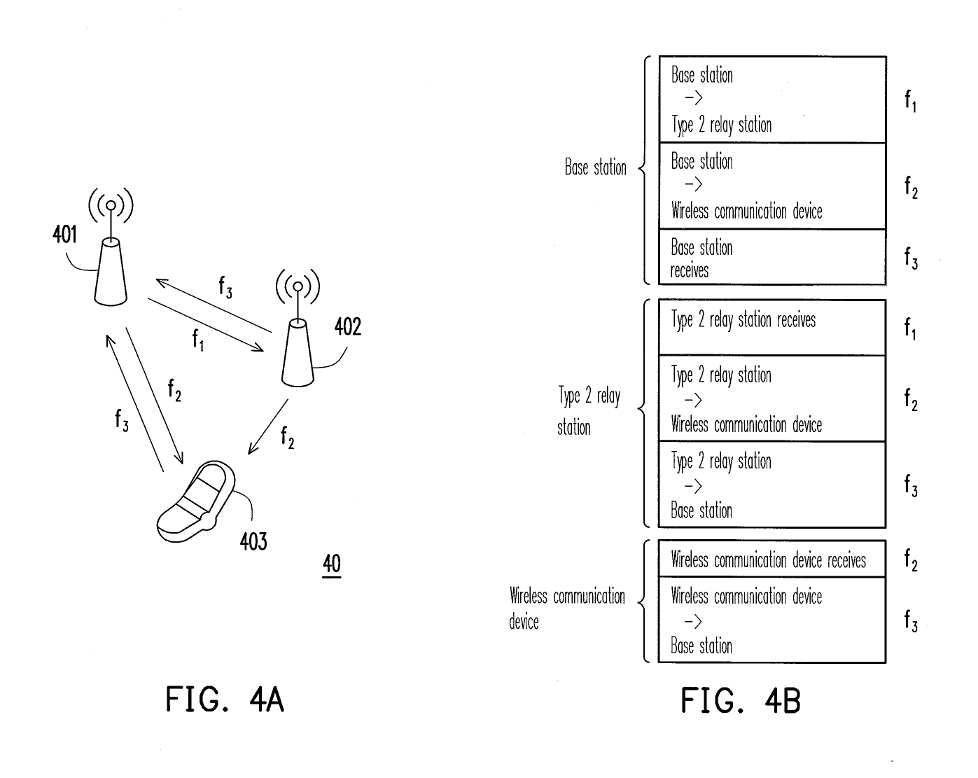

FIG. 4A is a schematic diagram illustrating a wireless communication system 40 with a type 2 relay station according to a first exemplary embodiment. The wireless communication system 40 includes a base station 401 (for example, an eNodeB), a type 2 relay station 402, and a wireless communication device 403. FIG. 4B is a schematic diagram illustrating the transmitting/receiving mechanism of the wireless communication system 40 in FIG. 4A. Referring to both FIG. 4A and FIG. 4B, in the wireless communication system 40, a frequency division duplex (FDD) mode is adopted as the transmission mode between the base station 401 and the type 2 relay station 402. That is, as shown in FIG. 4A, the downlink between the type 2 relay station 402 and the base station 401 uses a first band f₁, and the uplink between the two uses a third band f₃. Besides, the FDD mode is also adopted as the transmission mode between the type 2 relay station 402 and the wireless communication device 403. As shown in FIG. 4A, the downlink between the type 2 relay station 402 and the wireless communication device 403 uses a second band f₂. Besides, the FDD mode is also adopted as the transmission mode between the base station 401 and the wireless communication device 403. As shown in FIG. 4A, the downlink between the base station 401 and the wireless communication device 403 uses the second band f₂, and the uplink between the two uses the third band f₃.

The type 2 relay station 402 may just provide a data channel to the wireless communication device 403, and the base station 401 provides a control channel to the wireless communication device 403. To be illustrated more clearly, regarding the operation of the downlinks, the base station 401 transmits downlink data to the type 2 relay station 402 by using the first band f₁, and the type 2 relay station 402 receives the downlink data from the first band f₁. Besides, the type 2 relay station 402 transmits the downlink data to the wireless communication device 403 by using the second band f₂. Since the type 2 relay station 402 can receive and transmit downlink data at the same time, it is not needed to have the data receiving process and the data transmitting process respectively performed in separate two time slots.

Moreover, regarding the operation of the downlinks, the base station 401 transmits control signalling data to the wireless communication device 403 by using the second band f2 so as to coordinates the wireless communication device 403. For example, the base station 401 can transmit downlink control signalling data to the wireless communication device 403 through a physical downlink control channel (PDCCH), a physical hybrid-ARQ indicator (PHICH), or a physical control format indicator (PCFICH) in the 3rd Generation Partnership Project Long Term Evolution (3GPP LTE) standard. In addition, the base station 401 can also transmit the downlink control signalling data to the wireless communication device 403 through, for example, an advanced media access protocol (A-MAP) or a super frame header (SFH) in the IEEE 802.16m standard.

Regarding the operation of the downlinks, the type 2 relay station 402 and the base station 401 collaboratively or cooperatively transmit data to the wireless communication device 403 by using the second band f₂. For example, the type 2 relay station 402 can transmit downlink data to the wireless communication device 403 through a physical downlink shared channel (PDSCH) in the 3GPP LTE standard. The wireless communication device 403 receives the downlink data from the second band f₂.

Regarding the operation of the uplinks, the base station 401 coordinates the uplinks of the type 2 relay station 402 and the wireless communication device 403 by using the third band f₃. To be illustrated more clearly, the base station 401 coordinates the type 2 relay station 402 and the wireless communication device 403 in a same uplink data channel or a same uplink control channel by using the third band f₃. The type 2 relay station 402 and the wireless communication device 403 share the same uplink radio resources and the same uplink control channel. The uplinks of the type 2 relay station 402 and the wireless communication device 403 can transmit an uplink data and an uplink control signal at the same time. For example, the wireless communication device 403 or the type 2 relay station 402 may directly transmit the uplink data or the uplink control signal to the base station 401 through a physical uplink control channel (PUCCH), a physical uplink shared channel (PUSCH), or a random access channel (RACH) in the 3GPP LTE standard. In addition, the wireless communication device 403 or the type 2 relay station 402 can also directly transmit the uplink data or the uplink control signal to the base station 401 through, for example, a primary feedback channel (PFBCH) or a secondary feedback channel (SFBCH) in the IEEE 802.16m standard.

The base station 401, the type 2 relay station 402, and the wireless communication device 403 in the first exemplary embodiment are just examples for the purpose of illustration. In other embodiments of the present disclosure, the wireless communication system may further include more than one base station, and each of the base stations may cover more than one type 2 relay station and more than one wireless communication device. The aforementioned principle is also applicable to following third exemplary embodiment and fifth exemplary embodiment.

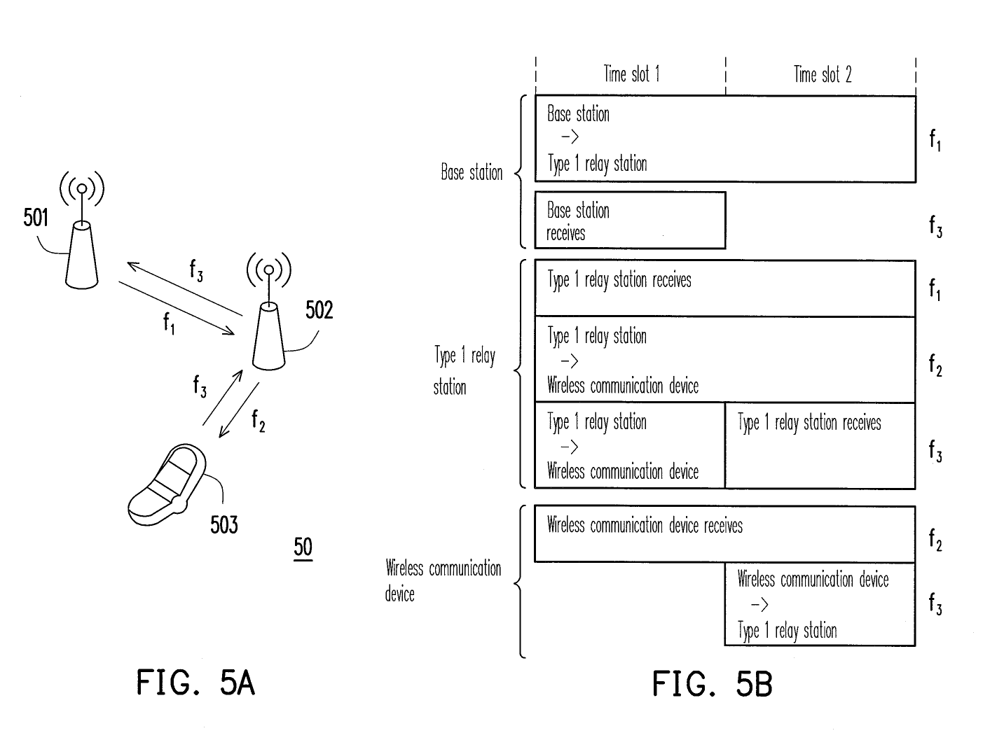

FIG. 5A is a schematic diagram illustrating a wireless communication system with a type 1 relay station according to a second exemplary embodiment. The wireless communication system 50 includes a base station 501, a type 1 relay station 502, and a wireless communication device 503. FIG. 5B is a schematic diagram illustrating the transmitting/receiving mechanism of the wireless communication system 50 in FIG. 5A. Referring to both FIG. 5A and FIG. 5B, the FDD mode is adopted as the transmission mode between the base station 501 and the type 1 relay station 502, and also adopted as the transmission mode between the type 1 relay station 502 and the wireless communication device 503. As shown in FIG. 5A, the downlink between the base station 501 and the type 1 relay station 502 uses a first band f₁, and the uplink between the two uses a third band f₃. Besides, the downlink between the type 1 relay station 502 and the wireless communication device 503 uses a second band f₂, and the uplink between the two uses the third band f₃. Since the uplinks of both the type 1 relay station 502 and the wireless communication device 503 use the third band f₃, the overall data transmitting process and data receiving process of the wireless communication system 50 is carried out in a time division multiplexing (TDM) mode in at least two time slots.

To be illustrated more clearly, regarding the operation of the downlinks, the base station 501 transmits downlink data or downlink control signalling data to the type 1 relay station 502 by using the first band f₁, and the type 1 relay station 502 receives the downlink data from the first band f₁. For example, the base station 501 can transmit the downlink control signalling data to the wireless communication device 503 through a PDCCH, a PHICH, a PCFICH, a PDSCH, a broadcast channel (BCH), or a synchronization channel (SCH) in the 3GPP LTE standard. For example, the base station 501 can also transmit the downlink data or the downlink control signalling data to the wireless communication device 503 through a A-MAP or a SFH in the IEEE 802.16m standard.

Regarding the operation of the downlinks, the type 1 relay station 502 transmits the downlink data or the downlink control signalling data to the wireless communication device 503 by using the second band f₂, and the wireless communication device 503 receives the downlink data from the second band f₂. For example, the type 1 relay station 502 can transmit the downlink data or the downlink control signalling data to the wireless communication device 503 through a PDCCH, a PHICH, a PCFICH, a PDSCH, a BCH, or a SCH in the 3GPP LTE standard. The type 1 relay station 502 may also transmit the downlink data or the downlink control signalling data to the wireless communication device 503 through a A-MAP or a SFH in the IEEE 802.16m standard.

Regarding the operation of the uplinks, the type 1 relay station 502 and the wireless communication device 503 can both be connected to the uplink of the base station 501 in a code division multiplexing (CDM) mode, a TDM mode, a FDM mode, or any hybrid of these three modes. In other words, a first uplink from the type 1 relay station 502 to the base station 501 and a second uplink of the wireless communication device 503 can share the third band f₃ through the CDM mode, the TDM mode, the FDM mode, or any hybrid of the three modes, so as to transmit uplink data or uplink control signalling data by using the third band f₃.

The following example illustrates how both the type 1 relay station 502 and the wireless communication device 503 are connected to the uplink of the base station 501 through the TDM mode. The base station 501 coordinates the uplink between the type 1 relay station 502 and the wireless communication device 503 by using the third band f₃. The uplink can transmit uplink data and uplink control signalling data at the same time, and the type 1 relay station 502 and the wireless communication device 503 share the uplink. In other words, the base station 501 coordinates the type 1 relay station 502 and the wireless communication device 503 in a same uplink data channel or a same uplink control channel, where the uplink data channel or the uplink control channel operates in the third band f₃. For example, the wireless communication device 503 can directly transmit the uplink data or the uplink control signalling data to the type 1 relay station 502 through a PUCCH, a PUSCH, or a RACH in the 3GPP LTE standard.

Furthermore, the wireless communication device 503 can also directly transmit the uplink data or the uplink control signalling data to the type 1 relay station 502 through, for example, a PFBCH and a SFBCH in the IEEE 802.16m standard. Similarly, the type 1 relay station 502 can directly transmit the uplink data or the uplink control signalling data to the base station 501 through, for example, a PUCCH, a PUSCH, or a RACH in the 3GPP LTE standard. In addition, the type 1 relay station 502 can also directly transmit the uplink data or the uplink control signalling data to the base station 501 through a PFBCH or a SFBCH in the IEEE 802.16m standard.

Referring to FIG. 5B, in the time slot 1, the type 1 relay station 502 transmits the uplink data or the uplink control signalling data to the base station 501 by using the third band f₃, and the base station 501 receives the uplink data or the uplink control signalling data from the third band f₃. In the time slot 2, the wireless communication device 503 transmits the uplink data or the uplink control signalling data to the type 1 relay station 502 by using the third band f₃, and the type 1 relay station 502 receives the uplink data or the uplink control signalling data from the third band f₃.

In order to allow the type 1 relay station 502 to receive an uplink data from the wireless communication device 503 and transmit another uplink data to the base station 501 at the same time by using the third band f₃, the type 1 relay station 502 may adopt an antenna separation technique or a directional antenna. Moreover, the base station 501, the type 1 relay station 502, and the wireless communication device 503 in the second exemplary embodiment are just examples for the purpose of illustration. In other embodiments of the disclosure, the wireless communication system may further include more than one base station, and each of the base stations may cover more than one type 1 relay station and more than one wireless communication device. The aforementioned principle is also applicable to following fourth exemplary embodiment.

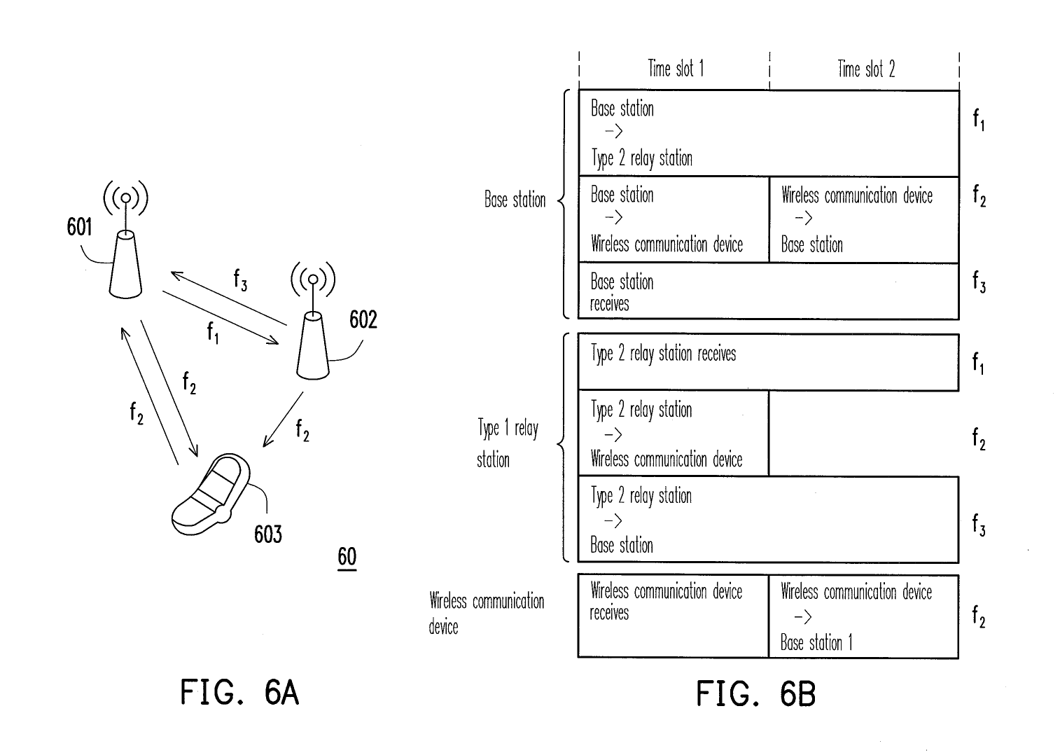

FIG. 6A is a schematic diagram illustrating a wireless communication system with a type 2 relay station according to a third exemplary embodiment. The wireless communication system 60 includes a base station 601, a type 2 relay station 602, and a wireless communication device 603. FIG. 6B is a schematic diagram illustrating the transmitting/receiving mechanism of the wireless communication system 60 in FIG. 6A. Referring to both FIG. 6A and FIG. 6B, a hybrid of the TDD operation mode and the FDD operation mode is adopted by the type 2 relay station 602. The FDD mode is adopted as the transmission mode between the base station 601 and the type 2 relay station 602, the TDD mode is adopted as the transmission mode between the base station 601 and the wireless communication device 603, and the FDD mode is also adopted as the transmission mode between the type 2 relay station 602 and the wireless communication device 603. As shown in FIG. 6A, the downlink between the base station 601 and the type 2 relay station 602 uses a first band f₁, and the uplink between the two uses a third band f₃. Besides, the downlink between the type 2 relay station 602 and the wireless communication device 603 uses a second band f₂. Both the downlink and the uplink between the wireless communication device 603 and the base station 601 use the second band f₂. Since both the downlink and the uplink between the wireless communication device 603 and the base station 601 use the second band f₂, the overall transmitting process and receiving process of the wireless communication system 60 is carried out in two time slots.

To be illustrated more clearly, regarding the operation of the downlinks, the base station 601 transmits downlink data to the type 2 relay station 602 by using the first band f₁, the type 2 relay station 602 receives the downlink data from the first band and the type 2 relay station 602 transmits the downlink data to the wireless communication device 603 by using the second band f₂. The base station 601 transmits downlink control signalling data by using the second band f₂, so as to coordinate the wireless communication device 603. For example, the base station 601 can transmit the downlink control signalling data to the wireless communication device 603 through a PDCCH, a PHICH, or a PCFICH in the 3GPP LTE standard. Moreover, the base station 601 can also transmit the downlink data or the downlink control signalling data to the wireless communication device 603 through, for example, a A-MAP or a SFH in the IEEE 802.16m standard. The base station 601 and the type 2 relay station 602 also cooperatively or collaboratively transmit the downlink data to the wireless communication device 603 by using the second band f₂, and the wireless communication device 603 receives the downlink data from the second band f₂.

Regarding the operation of the uplinks, an uplink data channel and an uplink control channel of the base station 601 can be realized by using the second band f₂. The uplink from the wireless communication device 603 to the base station 601 can transmit uplink data and uplink control signalling data at the same time. The base station 601 coordinates the wireless communication device 603 through a same first uplink data channel or a same first uplink control channel, where the first uplink data channel or the first uplink control channel operates in the second band f₂. Besides, the base station 601 coordinates the type 2 relay station 602 through a same second uplink data channel or a same second uplink control channel, where the second uplink data channel or the second uplink control channel operates in the third band f₃.

For example, the wireless communication device 603 can directly transmit the uplink data or the uplink control signalling data to the base station 601 through a PUCCH, a PUSCH, or a RACH in the 3GPP LTE standard by using the second band f₂. The first uplink data channel or the first uplink control channel can be, for example, the PUCCH, the PUSCH, or the RACH in the 3GPP LTE standard. Besides, the wireless communication device 603 can also directly transmit the uplink data or the uplink control signalling data to the base station 601 by using, for example, a PFBCH or a SFBCH in the IEEE 802.16m standard. The first uplink data channel or the first uplink control channel can be, for example, the PFBCH or the SFBCH in the IEEE 802.16m standard.

Similarly, the type 2 relay station 602 can directly transmit the uplink data or the uplink control signalling data to the base station 601 by using the third band f3 through, for example, a PUCCH, a PUSCH, or a RACH in the 3GPP LTE standard. The second uplink data channel or the second uplink control channel can be, for example, the PUCCH, the PUSCH, or the RACH in the 3GPP LTE standard. Moreover, the type 2 relay station 602 can also directly transmit the uplink data or the uplink control signalling data to the base station 601 through, for example, a PFBCH and a SFBCH in the IEEE 802.16m standard. The second uplink data channel or the second uplink control channel can be, for example, the PFBCH and the SFBCH in the IEEE 802.16m standard.

Referring to FIG. 6B, in the time slot 1, both the base station 601 and the type 2 relay station 602 both transmit downlink data or downlink control signalling data to the wireless communication device 603 by using the second band f₂, and the wireless communication device 603 receives the downlink data or the downlink control signalling data from the second band f₂. In the time slot 2, the wireless communication device 603 transmits the uplink data or the uplink control signalling data to the base station 601 by using the second band f₂, and the base station 601 receives the uplink data or the uplink control signalling data from the second band f₂.

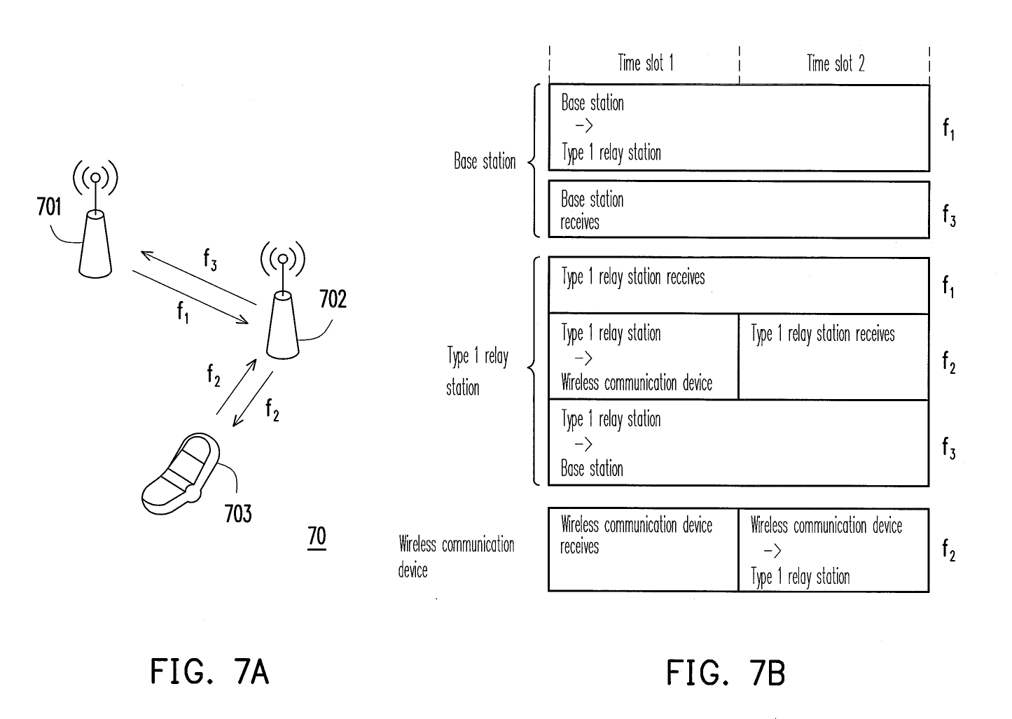

FIG. 7A is a schematic diagram illustrating a wireless communication system with a type 1 relay station according to a fourth exemplary embodiment. The wireless communication system 70 includes a base station 701, a type 1 relay station 702, and a wireless communication device 703. FIG. 7B is a schematic diagram illustrating the transmitting/receiving mechanism of the wireless communication system 70 in FIG. 7A. Referring to both FIG. 7A and FIG. 7B, in the wireless communication system 70, the FDD mode is adopted as the transmission mode between the base station 701 and the type 1 relay station 702, and the TDD mode is adopted as the transmission mode between the type 1 relay station 702 and the wireless communication device 703. Since the TDD mode is adopted between the type 1 relay station 702 and the wireless communication device 703, the overall transmitting process and receiving process of the wireless communication system 70 is carried out in two time slots. In the time slot 1, the type 1 relay station 702 transmits downlink data or downlink control signalling data to the wireless communication device 703 by using a second band f₂, and the wireless communication device 703 receives the downlink data or the downlink control signalling data from the second band f₂. In the time slot 2, the wireless communication device 703 transmits uplink data or uplink control signalling data to the wireless communication device 703 by using the second band f₂, and the wireless communication device 703 receives the uplink data or the uplink control signalling data from the second band f₂.

To be illustrated more clearly, regarding the operation of the downlinks, the base station 701 transmits the downlink data or the downlink control signalling data to the type 1 relay station 702 by using the first band f₁. For example, the base station 701 can transmit data or control signalling data to the wireless communication device 703 through a PDCCH, a PHICH, a PCFICH, a PDSCH, a BCH, or a SCH in the 3GPP LTE standard. For example, the base station 701 can also transmit the downlink data or the downlink control signalling data to the wireless communication device 703 through a A-MAP or a SFH in the IEEE 802.16m standard.

The type 1 relay station 702 transmits the downlink data or the downlink control signalling data to the wireless communication device 703 by using the second band f₂. For example, the type 1 relay station 702 can transmit the downlink data or the downlink control signalling data to the wireless communication device 703 through a PDCCH, a PHICH, a PCFICH, a PDSCH, a BCH, or a SCH in the 3GPP LTE standard. For example, the type 1 relay station 702 can also transmit the downlink data or the downlink control signalling data to the wireless communication device 703 through a A-MAP and a SFH in the IEEE 802.16m standard.

Regarding the operation of the uplinks, the base station 701 receives the data or the control signalling data from the type 1 relay station 702 by using the third band f₃. The type 1 relay station 702 can directly transmit the uplink data or the uplink control signal to the base station 701 by using the third band f₃ through, for example, a PUCCH, a PUSCH, or a RACH in the 3GPP LTE standard. The type 1 relay station 702 can also directly transmit the uplink data or the uplink control signalling data to the base station 701 through, for example, a PFBCH and a SFBCH in the IEEE 802.16m standard. Similarly, the type 1 relay station 702 receives the uplink data or the uplink control signalling data from the wireless communication device 703 by using the third band f₃. The wireless communication device 703 can directly transmit the uplink data or the uplink control signalling data to the type 1 relay station 702 by using the second band f₂ through, for example, a PUCCH, a PUSCH, or a RACH in the 3GPP LTE standard. In addition, the wireless communication device 703 can also directly transmit the uplink data or the uplink control signalling data to the type 1 relay station 702 through, for example, a PFBCH or a SFBCH in the IEEE 802.16m standard.

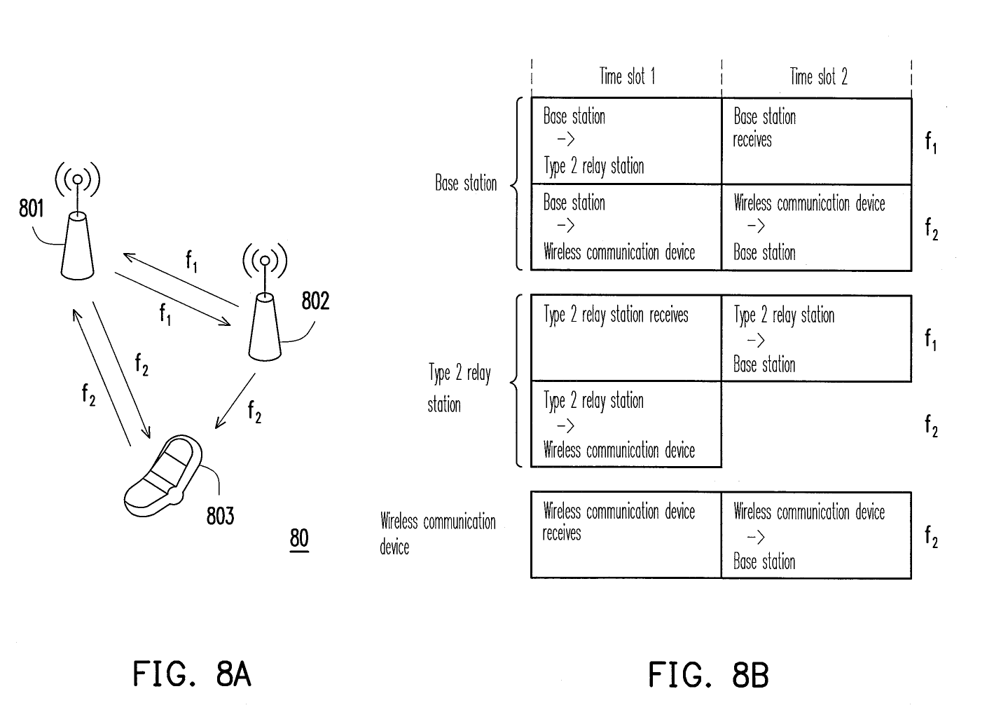

FIG. 8A is a schematic diagram illustrating a wireless communication system with a type 2 relay station according to a fifth exemplary embodiment. The wireless communication system 80 includes a base station 801, a type 2 relay station 802, and a wireless communication device 803. FIG. 8B is a schematic diagram illustrating the transmitting/receiving mechanism of the wireless communication system 80 in FIG. 8A. Referring to both FIG. 8A and FIG. 8B, the TDD mode is adopted by the type 2 relay station 802. The TDD mode is adopted as the transmission mode between the base station 801 and the type 2 relay station 802 and between the base station 801 and the wireless communication device 803, and the type 2 relay station 802 and the wireless communication device 803 are connected in a uni-direction link. As shown in FIG. 8A, both the uplink and the downlink between the base station 801 and the type 2 relay station 802 use a first band f₁. The downlink between the type 2 relay station 802 and the wireless communication device 803 uses a second band f₂, and both the uplink and the downlink between the base station 801 and the wireless communication device 803 also use the second band f₂. Since the TDD mode is adopted as the transmission mode between the base station 801 and the type 2 relay station 802 and also adopted as the transmission mode between the base station 801 and the wireless communication device 803, the overall data transmitting process and receiving process of the wireless communication system 80 is carried out in two time slots.

To be illustrated more clearly, regarding the operation of the downlinks, the base station 801 transmits downlink data to the type 2 relay station 602 by using the first band f₁, the type 2 relay station 802 receives the downlink data from the first band f₁, and the type 2 relay station 802 transmits the downlink data to the wireless communication device 803 by using the second band f₂. The base station 801 transmits downlink control signalling data to the wireless communication device 803 by using the second band f₂, so as to coordinate the wireless communication device 803. For example, the base station 801 can transmit the downlink control signalling data to the wireless communication device 803 through a PDCCH, a PHICH, or a PCFICH in the 3GPP LTE standard. For example, the base station 801 can also transmit the downlink control signalling data to the wireless communication device 803 through a A-MAP and a SFH in the IEEE 802.16m standard. The base station 801 and the type 2 relay station 802 also cooperatively or collaboratively transmit the downlink data to the wireless communication device 803 by using the second band f₂, and the wireless communication device 803 receives the downlink data from the second band f₂.

Regarding the operation of the uplinks, an uplink data channel and an uplink control channel of the wireless communication device 803 to the base station 801 are realized by using the second band f₂. Namely, the uplink from the wireless communication device 803 to the base station 801 can transmit uplink data and uplink control signalling data at the same time. For example, the wireless communication device 803 can directly transmit the uplink data or the uplink control signalling data to the base station 801 by using the second band f₂ through a PUCCH, a PUSCH, or a RACH in the 3GPP LTE standard. In addition, the wireless communication device 803 can also directly transmit the uplink data or the uplink control signalling data to the base station 601 through, for example, a PFBCH or a SFBCH in the IEEE 802.16m standard.

Similarly, an uplink data channel and an uplink control channel of the type 2 relay station 802 to the base station 801 are realized by using the first band f₁. Namely, the uplink from the type 2 relay station 802 to the base station 801 can transmit uplink data and uplink control signalling data at the same time. For example, the type 2 relay station 802 can directly transmit the uplink data or the uplink control signalling data to the base station 801 by using the first band f₁ through, for example, a PUCCH, a PUSCH, or a RACH in the 3GPP LTE standard. In addition, the type 2 relay station 802 can also directly transmit the uplink data or the uplink control signal to the base station 801 through, for example, a PFBCH and a SFBCH in the IEEE 802.16m standard.

Referring to FIG. 8B, in the time slot 1, the base station 801 transmits downlink data to the type 2 relay station 802 by using the first band f₁ and transmits downlink data or downlink control signalling data to the wireless communication device 803 by using the second band f₂, and the type 2 relay station 802 further transmits the downlink data to the wireless communication device 803 by using the second band f₂. In the time slot 1, the type 2 relay station 802 receives the downlink data from the first band f₂, and the wireless communication device 803 receives the downlink data or the downlink control signalling data from the second band f₂. In the time slot 2, the type 2 relay station 802 transmits uplink data or uplink control signalling data to the base station 801 by using the first band f₁, and the wireless communication device 803 transmits uplink data or uplink control signalling data to the base station 801 by using the second band f₂. In the time slot 2, the base station 801 receives the uplink data of the type 2 relay station 802 from the first band f₁ and receives the uplink data and the uplink control signalling data of the wireless communication device 803 from the second band f₂.

In summary, exemplary embodiments of the disclosure provide a wireless communication system and a relay station and a wireless communication device thereof. In the wireless communication system, inband or outband radio resources are used in uplinks and downlinks, along with the TDD and FDD techniques being appropriately adopted, so that the highest transmission rate of the wireless communication device can be improved when a relay technique is adopted. In addition, transition gaps between uplinks and downlinks of relaying process are reduced, and less number of carriers are used, so that utilization efficiency of radio resources can be improved.

It will be apparent to those skilled in the art that various modifications and variation can be made to the structure of the disclosed embodiments without departing from the scope or spirit of the disclosure. In view of the foregoing, it is intended that the disclosure cover modifications and variation of this disclosure provided they fall within the scope of the following claims and their equivalents.

What is claimed is:

1. A wireless communication system, comprising:
at least a base station;
at least a relay station, wirelessly connected to the base station; and
at least a wireless communication device, wirelessly connected to the relay station, wherein at least two uplinks of the wireless communication system are inband, and at least two downlinks of the wireless communication system are outband.

2. The wireless communication system according to claim 1, wherein
a frequency division duplex (FDD) mode is adopted as a first transmission mode between the at least a base station and the at least a relay station;
the FDD mode is adopted as a second transmission mode between the at least a base station and the at least a wireless communication device;
the base station transmits downlink data to the at least a relay station by using a first band;
the at least a relay station receives the downlink data from the first band;
the at least a base station and the at least a relay station transmit the downlink data to the wireless communication device by using a second band;
the at least a wireless communication device receives the downlink data from the second band;
the at least a base station further transmits a downlink control signalling data to the at least a wireless communication device by using the second band; and
the at least a base station coordinates the at least a relay station and the at least a wireless communication device in a same uplink data channel or a same uplink control channel.

3. The wireless communication system according to claim 2, wherein,
at least a channel used by the at least a relay station for transmitting the downlink data to the at least a wireless communication device comprises a physical downlink shared channel (PDSCH) in a 3rd Generation Partnership Project Long Term Evolution (3GPP LTE) standard;
at least a channel used by the at least a base station for transmitting the downlink data to the at least a wireless communication device comprises a PDCCH, a physical hybrid-arq indicator channel (PHICH), and a physical control format indicator channel (PCFICH) in the 3GPP LTE standard; and
the uplink data channel or the uplink control channel comprises a physical uplink control channel (PUCCH), a physical uplink shared channel (PUSCH), and a random access channel (RACH) in the 3GPP LTE standard.

4. The wireless communication system according to claim 2, wherein
at least a channel used by the at least a base station for transmitting the downlink data to the at least a wireless communication device comprises an advanced media access protocol (A-MAP) and a super frame header (SFH) in an IEEE 802.16m standard; and
the uplink data channel or the uplink control channel comprises a primary feedback channel (PFBCH) and a secondary feedback channel (SFBCH) in the IEEE 802.16m standard.

5. The wireless communication system according to claim 1, wherein
an FDD mode is adopted as a first transmission mode between the at least a base station and the at least a relay station;
the FDD mode is adopted as a second transmission mode between the at least a base station and the at least a wireless communication device;
the at least a base station transmits downlink data or downlink control signalling data to the at least a relay station by using a first band;
the at least a relay station receives the downlink data or the downlink control signalling data from the first band;
the at least a relay station transmits the downlink data or the downlink control signalling data to the at least a wireless communication device by using a second band;
the at least a wireless communication device receives the downlink data or the downlink control signalling data from the second band; and
the at least a base station coordinates the at least a relay station and the at least a wireless communication device in a same uplink data channel or a same uplink control channel, wherein the uplink data channel or the uplink control channel operates in a third band.

6. The wireless communication system according to claim 5, wherein
at least a channel used by the at least a base station for transmitting the downlink data or the downlink control signalling data to the at least a relay station comprises a PDCCH, a PHICH, a PCFICH, a PDSCH, a broadcast channel (BCH), and a synchronization channel (SCH) in the 3GPP LTE standard; and
the uplink data channel or the uplink control channel comprises a PUCCH, a PUSCH, and a RACH in the 3GPP LTE standard.

7. The wireless communication system according to claim 5, wherein
at least a channel used by the at least a base station for transmitting the downlink data or the downlink control signalling data to the at least a relay station comprises an A-MAP and a SFH in the IEEE 802.16m standard;
the uplink data channel or the uplink control channel comprises a PFBCH and a SFBCH in the IEEE 802.16m standard.

8. The wireless communication system according to claim 5, wherein the at least a relay station has a directional antenna such that the at least a relay station simultaneously receives a downlink data and transmits another downlink data by using the third band.

9. A wireless communication system, comprising:
at least a base station;
at least a relay station, wirelessly connected to the base station, wherein an FDD mode is adopted as a first transmission mode between the at least a base station and the at least a relay station; and
at least a wireless communication device, wirelessly connected to the at least a relay station, wherein a time division duplex (TDD) mode is adopted as a second transmission mode between the at least a relay station and the at least a wireless communication device.

10. The wireless communication system according to claim 9, wherein,
the TDD mode is adopted as a third transmission mode between the at least a base station and the at least a wireless communication device;
the at least a base station transmits downlink data to the at least a relay station by using a first band;
the at least a relay station receives the downlink data from the first band;
the at least a base station and the at least a relay station transmit the downlink data to the at least a wireless communication device by using a second band;
the at least a wireless communication device receives the downlink data from the second band;
the at least a base station further transmits a control signalling data to the at least a wireless communication device by using the second band, so as to coordinate the at least a wireless communication device;
the at least a base station coordinates the at least a wireless communication device in a same first uplink data channel or a same first uplink control channel, wherein the first uplink data channel or the first uplink control channel operates in the second band; and
the at least a base station coordinates the at least a relay station in a same second uplink data channel or a second uplink control channel, wherein the second uplink data channel or the second uplink control channel operates in a third band.

11. The wireless communication system according to claim 10, wherein,
at least a channel used by the at least a base station for transmitting the downlink control signalling data to the at least a wireless communication device comprises a PDCCH, a PHICH, and a PCFICH in a 3GPP LTE standard.
the first uplink data channel or the first uplink control channel comprises a PUCCH, a PUSCH, and a RACH in the 3GPP LTE standard; and
the second uplink data channel or the second uplink control channel comprises a PUCCH, a PUSCH, and a RACH in the 3GPP LTE standard.

12. The wireless communication system according to claim 10, wherein
at least a channel used by the at least a base station for transmitting the downlink control signalling data to the at least a wireless communication device comprises an A-MAP and a SFH in an IEEE 802.16m standard;
the first uplink data channel or the first uplink control channel comprises a PFBCH and a SFBCH in the IEEE 802.16m standard; and
the second uplink data channel or the second uplink control channel comprises a PFBCH and a SFBCH in the IEEE 802.16m standard.

13. The wireless communication system according to claim 9, wherein,
the at least a base station transmits downlink data or downlink control signalling data to the at least a relay station by using a first band;
the at least a relay station receives the downlink data or the downlink control signalling data from the first band;
the at least a relay station transmits the downlink data or the downlink control signalling data to the at least a wireless communication device by using a second band;
the at least a wireless communication device receives the downlink data or the downlink control signalling data from the second band;
the at least a wireless communication device transmits uplink data or uplink control signalling data to the at least a relay station by using the second band; and
the at least a relay station transmits the uplink data or the uplink control signalling data to the at least a base station by using a third band.

14. The wireless communication system according to claim 13, wherein
at least a channel used by the base station for transmitting the downlink data or the downlink control signalling data to the at least a relay station comprises a PDCCH, a PHICH, a PCFICH, a PDSCH, a BCH, and a SCH in the 3GPP LTE standard;
at least a channel used by the at least a relay station for transmitting the downlink data or the downlink control signalling data to the at least a wireless communication device comprises a PDCCH, a PHICH, a PCFICH, a PDSCH, a BCH, and a SCH in the 3GPP LTE standard; and
at least a channel used by the at least a relay station for transmitting uplink data or the uplink control signalling data to the at least a base station comprises a PUCCH, a PUSCH, and a RACH in the 3GPP LTE standard.

15. The wireless communication system according to claim 13, wherein
at least a channel used by the at least a base station for transmitting downlink data or the downlink control signalling data to the at least a relay station comprises an A-MAP and a SFH in the IEEE 802.16m standard;
at least a channel used by the at least a relay station for transmitting the downlink data or the downlink control signalling data to the at least a wireless communication device comprises an A-MAP and a SFH in the IEEE 802.16m standard; and
at least a channel used by the relay station for transmitting the uplink data or the uplink control signalling data to the at least a base station comprises a PFBCH and a SFBCH in the IEEE 802.16m standard.

16. A relay station, adapted for relaying data or control signalling data between at least a base station and at least a wireless communication device, wherein a first uplink of the relay station and a second uplink of the wireless communication device are inband, and a first downlink of the relay station and a second downlink of the wireless communication device are outband.

17. The relay station according to claim 16, wherein,
an FDD mode is adopted as a transmission mode between the base station and the relay station;
the relay station receives downlink data from a first band;
the at least a base station and the relay station transmit second data to the at least a wireless communication device by using a second band; and
the at least a base station coordinates the relay station in a same uplink data channel or a same uplink control channel.

18. The relay station according to claim 17, wherein,
at least a channel used by the relay station for transmitting the downlink data to the at least a wireless communication device comprises a PDSCH in a 3GPP LTE standard; and
the uplink data channel or the uplink control channel comprises a PUCCH, a PUSCH, and a RACH in the 3GPP LTE standard.

19. The relay station according to claim 17, wherein the uplink data channel or the uplink control channel comprises a PFBCH and a SFBCH in the IEEE 802.16m standard.

20. The relay station according to claim 16, wherein,
an FDD mode is adopted as a first transmission mode between the relay station and the at least a base station;
the FDD mode is adopted as a second transmission mode between the relay station and the at least a wireless communication device;
the relay station receives a downlink data or a downlink control signalling data from a first band;
the relay station transmits the downlink data or the downlink control signalling data by using a second band; and
an uplink data channel or an uplink control channel of the relay station operates in a third band.

21. The relay station according to claim 20, wherein,
at least a channel used by the relay station for receiving the downlink data or the downlink control signalling data comprises a PDCCH, a PHICH, a PCFICH, a PDSCH, a BCH, and a SCH in the 3GPP LTE standard; and
the uplink data channel or the uplink control channel comprises a PUCCH, a PUSCH, and a RACH in the 3GPP LTE standard.

22. The relay station according to claim 20, wherein,
at least a channel used by the relay station for receiving the downlink data or the downlink control signalling data comprises an A-MAP and a SFH in the IEEE 802.16m standard; and
the uplink data channel or the uplink control channel comprises a PFBCH and a SFBCH in the IEEE 802.16m standard.

23. A relay station, adapted for relaying data or control signalling data between at least a base station and at least a wireless communication device, wherein an FDD mode is adopted as a first transmission mode between the relay station and the at least a base station, and a TDD mode is adopted as a second transmission mode between the relay station and the at least a wireless communication device.

24. The relay station according to claim 23, wherein,
the relay station receives downlink data from a first band;
the relay station transmits the downlink data by using a second band;
the at least a base station and the relay station transmit the downlink data to the at least a wireless communication device by using the second band; and
an uplink data channel or an uplink control channel of the relay station operates in a third band.

25. The relay station according to claim 24, wherein the uplink data channel or the uplink control channel comprises a PUCCH, a PUSCH, and a RACH in a 3GPP LTE standard.

26. The relay station according to claim 24, wherein the uplink data channel or the uplink control channel comprises a PFBCH and a SFBCH in an IEEE 802.16m standard.

27. The relay station according to claim 23, wherein,
the relay station receives first downlink data or first downlink control signalling data from a first band;
the relay station transmits second downlink data or second downlink control signalling data to the at least a wireless communication device by using a second band;
the relay station receives uplink data or uplink control signalling data from the second band; and
the relay station transmits the uplink data or the uplink control signalling data by using a third band.

28. The relay station according to claim 27, wherein,
at least a channel used by the relay station for transmitting the second downlink data or the second downlink control signalling data comprises a PDCCH, a PHICH, a PCFICH, a PDSCH, a BCH, and a SCH in the 3GPP LTE standard; and
at least a channel used by the relay station for transmitting the uplink data or the uplink control signalling data comprises a PUCCH, a PUSCH, and a RACH in the 3GPP LTE standard.

29. The relay station according to claim 27, wherein,
at least a channel used by the relay station for transmitting the second downlink data or the second downlink control signalling data comprises an A-MAP and a SFH in the IEEE 802.16m standard; and
at least a channel used by the relay station for transmitting the uplink data or the uplink control signalling data comprises a PFBCH and a SFBCH in the IEEE 802.16m standard.

30. A wireless communication device, adapted for communicating with at least a base station through at least a relay station, wherein
an FDD mode is adopted as a transmission mode between the at least a wireless communication device and the relay station;
a frequency division multiplexing (FDM) mode is adopted by a first downlink of the at least a wireless communication device and a second downlink of the relay station; and
a first uplink of the at least a wireless communication device and a second uplink of the relay station share a same carrier.

31. The wireless communication device according to claim 30, wherein a first uplink of the at least a wireless communication device and a second uplink of the relay station share a same carrier, and the first uplink and the second uplink coexist in the same carrier by adopting a time division multiplexing (TDM) mode.

32. The wireless communication device according to claim 31, wherein,
an uplink of the at least a wireless communication device in the carrier does not transmit uplink data or uplink control signalling data to the relay station, and the relay station transmits uplink data or uplink control signalling data; and
the wireless communication device transmits the uplink data or the uplink control signalling data to the relay station, and the relay station does not transmit an uplink data or an uplink control signalling data to the base station.

33. The wireless communication device according to claim 30, wherein a first uplink of the wireless communication device and a second uplink of the relay station share a same carrier, and the first uplink and the second uplink coexist in the same. carrier wave by adopting an FDM mode.

34. The wireless communication device according to claim 30, wherein a first uplink of the wireless communication device and a second uplink of the relay station share a same carrier, and the first uplink and the second uplink coexist in the same carrier by adopting a code division multiplexing (CDM) mode.
